(19) United States
(12) Patent Application Publication
(10) Pub. No.: US 2019/0219119 A1
(43) Pub. Date: Jul. 18, 2019

(54) COMBINATION BRAKE PAD WEAR SENSOR AND BRAKE TEMPERATURE SENSOR

(71) Applicant: SAF-HOLLAND, Inc., Muskegon, MI (US)

(72) Inventors: Randy L. Schutt, Holland, MI (US); Ahmad Nizam Mohamad Jembari, Grand Haven, MI (US)

(21) Appl. No.: 16/248,073

(22) Filed: Jan. 15, 2019

Related U.S. Application Data
(60) Provisional application No. 62/617,810, filed on Jan. 16, 2018.

(51) Int. Cl. F16D 66/02; B60T 17/22

(52) U.S. Cl. CPC F16D 66/024; F16D 2066/001; B60T 17/22; F16D 66/027

(57) ABSTRACT

A brake assembly includes a brake pad mounting member, a brake pad mounted to the brake pad mounting member, and a sensor arrangement that includes a sensor housing extending through the brake pad mounting member and including an interior space, a temperature sensor extending at least partially through the interior space and located proximate a brake pad mounting member, the temperature sensor configured to sense a temperature of the brake pad mounting member, and a wear sensor extending at least partially through the interior space and located proximate the brake pad, the wear sensor configured to sense a wear of the brake pad.

### CROSS-REFERENCE TO RELATED APPLICATIONS

This application claims the benefit of U.S. Provisional Patent Application No. 62/617,810, filed on Jan. 16, 2018, entitled “COMBINATION BRAKE PAD WEAR SENSOR AND BRAKE TEMPERATURE SENSOR,” the entire disclosure of which is incorporated herein by reference.

### BACKGROUND

The embodiments disclosed herein relate to brake pad wear sensors and brake temperature sensors for heavy-duty, commercial vehicles, such as semi-tractors and trailers, and in particular to a combined brake pad wear sensor and brake temperature sensor for drum brake arrangements and disc brake arrangements.

### BRIEF SUMMARY

An embodiment of a brake assembly includes a brake pad mounting member, a brake pad mounted to the brake pad mounting member, and a sensor arrangement. The sensor arrangement includes a sensor housing extending through the brake pad mounting member and including an interior space, a temperature sensor extending at least partially through the interior space and located proximate a brake pad mounting member, the temperature sensor configured to sense a temperature of the brake pad mounting member, and a wear sensor extending at least partially through the interior space and located proximate the brake pad, the wear sensor configured to sense a wear of the brake pad.

Another embodiment includes a brake temperature and wear sensor arrangement that includes a sensor housing including an interior space and a threaded portion, the sensor housing configured to threadably received within a threaded aperture of a brake pad mounting member, a temperature sensor located within the interior space and configured to be located proximate the brake pad mounting member, the temperature sensor configured to sense a temperature of the brake pad mounting member, and a wear sensor extending at least partially through the interior space and is configured to be located proximate a brake pad, the wear sensor configured to sense a wear of the brake pad.

Yet another embodiment includes a brake temperature and wear sensor arrangement that includes a sensor housing including a head portion, a shaft portion and an interior space extending longitudinally along the sensor housing though the head portion and the shaft portion, the head portion having a first width and the shaft portion have a second width that is less than the first width, the shaft portion including a threaded portion configured to be threadably received within a threaded aperture of a brake pad mounting member, a temperature sensor located entirely within the interior space and configured to be located proximate the brake pad mounting member, the temperature sensor configured to sense a temperature of the brake pad mounting member, and a wear sensor extends through and from within the interior space and is configured to be located proximate a brake pad, the wear sensor configured to sense a wear of the brake pad. The embodiment further includes a circuit board at least partially located within the interior space, and wherein the circuit board includes at least part of the temperature sensor and the wear sensor, wherein the temperature sensor, the wear sensor and the circuit board are secured within the interior space by an adhesive.

The principal objects of the embodiments as disclosed herein are to provide a sensor arrangement that senses both brake temperature and brake pad wear within a single, compact assembly, provide an uncomplicated design that can be easily and quickly assembled within both drum brake assemblies and disc brake assemblies without the use of specialized tools. The embodiments as disclosed herein are efficient in use, economical to manufacture, capable of operating for the life of the associated brake assemblies, and are particularly well adapted for the proposed use.

These and other features, advantages, and objects of the embodiments as shown and described herein will be further understood and appreciated by those skilled in the art by reference to the following specification, claims, and appended drawings.

### BRIEF DESCRIPTION OF THE DRAWINGS

FIG. 1 is a perspective view of a portion of a trailing arm-type suspension assembly including a sensor arrangement arranged within a drum brake assembly;

FIG. 2 is a cross-sectional side elevational view of the sensor assembly positioned within a drum brake pad assembly of the drum brake assembly, taken along the line II-II, FIG. 1;

FIG. 3 is a perspective view of the sensor assembly;

FIG. 4 is an end view of the sensor assembly; and

FIG. 5 is a partial cut-away view of the sensor assembly shown within a disc brake assembly.

### DETAILED DESCRIPTION

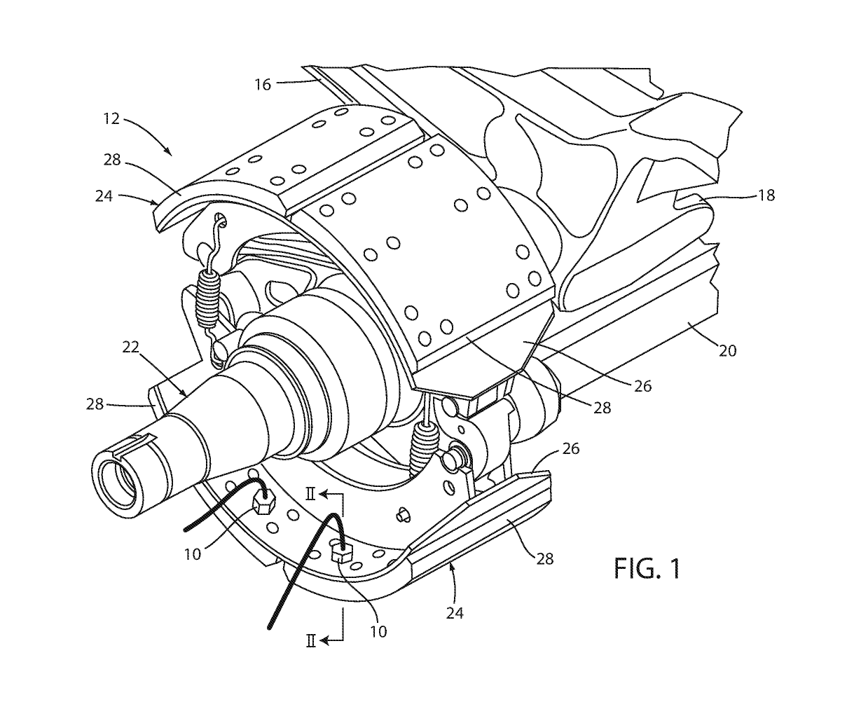

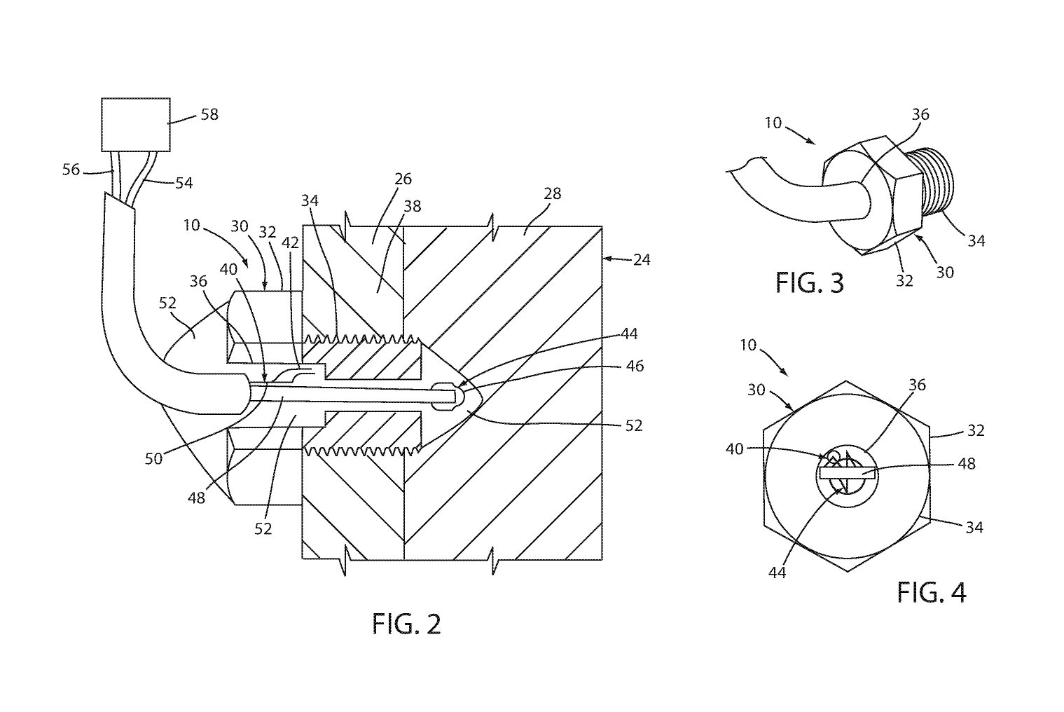

For purposes of description herein, the terms “upper,” “lower,” “right,” “left,” “rear,” “front,” “vertical,” “horizontal,” and the embodiments thereof shall relate to the embodiment as oriented in FIGS. 1 and 2. However, it is to be understood that the various embodiments as shown and described herein may assume various alternative orientations, except where expressly specified to the contrary. It is also to be understood that the specific devices and processes illustrated in the attached drawings, and described in the following specification are simply exemplary embodiments of the concepts defined in the appended claims. Hence, specific dimensions and other characteristics relating to the embodiments disclosed herein are not to be considered as limiting, unless the claims expressly state otherwise.

The reference numeral 10 (FIG. 1) generally designates a sensor assembly shown within a drum brake assembly 12 as illustrated within an overall trailing arm-type suspension assembly. While the suspension assembly 14 as illustrated in FIG. 1 includes a trailing arm-type suspension arrangement, other suspension arrangements may also be utilized. In the illustrated example, the suspension assembly 14 includes a trailing arm 16 having a first end (not shown) coupled to a vehicle frame member (not shown), and a second end 18 secured to an axle member 20. A spindle arrangement 22 is coupled to an end of the axle member 20 in a manner as is well known in the art.

In the illustrated example, the drum brake assembly 12 includes a pair of drum brake pad assemblies 24. Each drum brake pad assembly 24 includes a plate member or brake shoe 26 and a pair of brake pads 28. A plurality of the sensor assemblies 10 are longitudinally spaced from one another along the length of the plate member 26.

Each sensor assembly 10 (FIGS. 2 and 3) includes a sensor housing 30. In the illustrated example, the sensor housing 30 is configured as a bolt having a head portion 32 and a threaded shaft portion 34. A hollow interior space in the form of a bore 36 extending longitudinally through the head portion 32 and the threaded shaft portion 34.

As best illustrated in FIG. 2, the sensor assembly 10 is coupled to the associated pad assembly 24 by threading the threaded shaft portion 34 of the sensor housing 30 and into one of the threaded apertures 38 spaced along the length of the plate member 26.

The sensor assembly 10 further includes a temperature sensor arrangement 40. In the illustrated example, the temperature sensor arrangement 40 includes a temperature sensor 42 in the form of a thermocouple. However, it is noted that other temperature sensors may be utilized, including resistance temperature detectors, digital sensors, and the like. The sensor assembly 10 is configured such that the temperature sensor 42 is entirely located within the interior space 36, and is positioned proximate the plate member 26.

The sensor assembly 10 further includes a brake pad wear sensor arrangement 44. In the illustrated example, the brake pad wear sensor arrangement 44 includes a wear sensor 46 in the form of a wire. The wire or wear sensor 46 may extend through the length of the interior space 36 and extend from within the interior space 36 to a position that is proximate the brake pad 28.

The sensor assembly 10 may also include a circuit board 48 configured so as to include a portion of the temperature sensor arrangement 40 and a portion of the brake pad wear sensor arrangement 44. In the illustrated example, lead wires 50 of the temperature sensor arrangement 40 and a portion of the wire or wear sensor 46 are included within the circuit board 48. Use of the circuit board 48 may provide additional rigidity and mounting structure to the temperature sensor arrangement 40 and the brake pad wear sensor arrangement 44 for mounting within the interior space 36. In the illustrated example, the temperature sensor arrangement 40, the brake pad wear sensor arrangement 44 and the circuit board 48 are secured within the interior space 36 by a high temperature epoxy or other adhesive 52. Temperature sensor arrangement signal wires 54 and wear sensor arrangement signal wires 56 provide communication between the sensor arrangements 40, 44 and a controller 58 configured to communicate readings of the sensor arrangements 40, 44 with an operator.

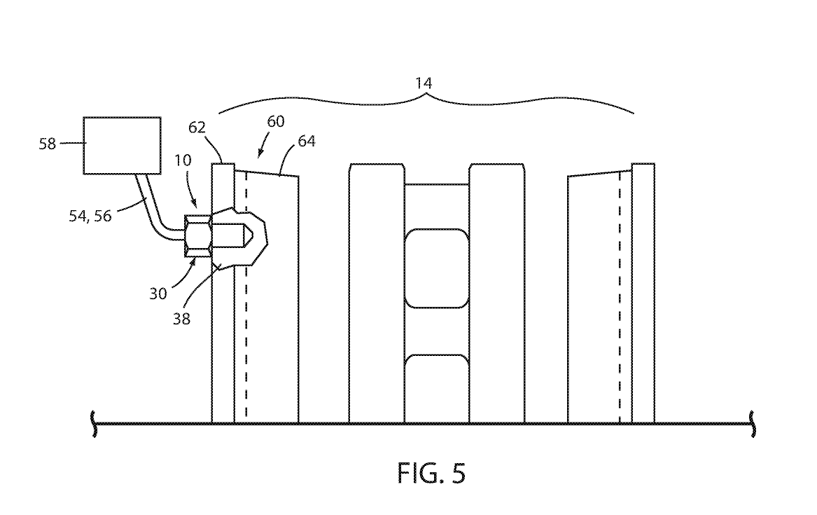

As best illustrated in FIG. 5, the sensor assembly 10 may also be utilized within a disc brake assembly 14. In the illustrated example, the disc brake assembly 14 includes disc brake pad assemblies 60 each including a plate member 62 and a brake pad 64. Similar to as discussed above with respect to the use of the sensor assembly 10 within the drum brake assembly 12, the sensor housing 30 is threadably coupled within a threaded aperture 38 of the plate member 62 such that the temperature sensor 42 of the temperature sensor arrangement 40 is located proximate the plate member 62 and the wear sensor 46 of the brake pad wear sensor arrangement 44 is located in an area proximate the brake pad 64.

The sensor assemblies as described above may be mounted at various and multiple locations within the associated drum brake assemblies and disc brake assemblies to provide signals indicating uneven brake pad wear, uneven heating within various regions of the associated brake pad, and/or to track thermal heat energy propagation through the associated brake pad assembly.

The embodiments of the sensor assembly disclosed herein provide a sensor arrangement that senses both brake temperature and brake pad wear within a single, compact assembly, provide an uncomplicated design that can be easily and quickly assembled within both drum brake assemblies and disc brake assemblies without the use of specialized tools. The embodiments as disclosed herein are efficient in use, economical to manufacture, capable of operating for the life of the associated brake assemblies, and are particularly well adapted for the proposed use

In the foregoing description, it will be readily appreciated by those skilled in the art that modifications may be made to the embodiments as disclosed herein without departing from the concepts is associated therewith. Such modifications are to be considered as included in the following claims, unless these claims by the language expressly state otherwise.

The invention claimed is:

1. A brake assembly, comprising:
a brake pad mounting member;
a brake pad mounted to the brake pad mounting member; and
a sensor arrangement, comprising:
a sensor housing extending through the brake pad mounting member and including an interior space;
a temperature sensor extending at least partially through the interior space and located proximate a brake pad mounting member, the temperature sensor configured to sense a temperature of the brake pad mounting member; and
a wear sensor extending at least partially through the interior space and located proximate the brake pad, the wear sensor configured to sense a wear of the brake pad.

2. The brake assembly of claim 1, wherein the sensor arrangement includes a circuit board at least partially located within the interior space, and wherein the circuit board includes at least part of the temperature sensor and the wear sensor.

3. The brake assembly of claim 2, wherein the circuit board is secured within the interior space by an adhesive.

4. The brake assembly of claim 1, wherein the sensor housing includes a threaded portion that is threadably received within a threaded aperture extending through the brake pad mounting member.

5. The brake assembly of claim 1, wherein the temperature sensor and the wear sensor are secured within the interior space by an adhesive.

6. The brake assembly of claim 1, wherein the temperature sensor is entirely located within the interior space.

7. The brake assembly of claim 1, wherein the temperature sensor includes a thermocouple.

8. The brake assembly of claim 1, wherein the wear sensor extends from within the interior space.

9. The brake assembly of claim 8, wherein the wear sensor includes a wire extending from within the interior space proximate the brake pad.

10. The brake assembly of claim 1, wherein the sensor arrangement is one of a plurality of sensor arrangements spaced from one another about the brake pad mounting member.

11. The brake assembly of claim 10, wherein the plurality of sensor arrangements are longitudinally space from one another along a length of the brake pad mounting member.

12. The brake assembly of claim 1, wherein the brake assembly comprises a drum brake assembly.

13. The brake assembly of claim 1, wherein the brake assembly comprises a disc brake assembly.

14. A brake temperature and wear sensor arrangement, comprising:
a sensor housing including an interior space and a threaded portion, the sensor housing configured to threadably received within a threaded aperture of a brake pad mounting member;
a temperature sensor located within the interior space and configured to be located proximate the brake pad mounting member, the temperature sensor configured to sense a temperature of the brake pad mounting member; and
a wear sensor extending at least partially through the interior space and is configured to be located proximate a brake pad, the wear sensor configured to sense a wear of the brake pad.

15. The sensor arrangement of claim 14, wherein the interior space includes a bore extending along a length of the sensor housing.

16. The sensor arrangement of claim 15, wherein the sensor housing includes a first portion that includes the threaded portion and having a first width, and a second portion having a second width that is greater than the first width.

17. The sensor arrangement of claim 14, further comprising:
a circuit board at least partially located within the interior space, and wherein the circuit board includes at least part of the temperature sensor and the wear sensor.

18. The sensor arrangement of claim 17, wherein the circuit board is secured within the interior space by an adhesive.

19. The sensor arrangement of claim 14, wherein the temperature sensor and the wear sensor are secured within the interior space by an adhesive.

20. The sensor arrangement of claim 14, wherein the temperature sensor is entirely located within the interior space.

21. The sensor arrangement of claim 14, wherein the temperature sensor includes a thermocouple.

22. The sensor arrangement of claim 14, wherein the wear sensor extends from within the interior space.

23. The sensor arrangement of claim 22, wherein the wear sensor includes a wire extending from within the interior space.

24. A brake temperature and wear sensor arrangement, comprising:
a sensor housing including a head portion, a shaft portion and an interior space extending longitudinally along the sensor housing though the head portion and the shaft portion, the head portion having a first width and the shaft portion have a second width that is less than the first width, the shaft portion including a threaded portion configured to be threadably received within a threaded aperture of a brake pad mounting member;
a temperature sensor located entirely within the interior space and configured to be located proximate the brake pad mounting member, the temperature sensor configured to sense a temperature of the brake pad mounting member; and
a wear sensor extends through and from within the interior space and is configured to be located proximate a brake pad, the wear sensor configured to sense a wear of the brake pad; and
a circuit board at least partially located within the interior space, and wherein the circuit board includes at least part of the temperature sensor and the wear sensor; and
wherein the temperature sensor, the wear sensor and the circuit board are secured within the interior space by an adhesive.
